(19) United States
(12) Patent Application Publication
(10) Pub. No.: US 2026/0131175 A1
(43) Pub. Date: May 14, 2026

(54) Respiratory mask

(71) Applicant: Samir Maamar Senouci, peron (FR)

(72) Inventor: Samir Maamar Senouci, peron (FR)

(21) Appl. No.: 19/119,628

(22) PCT Filed: Oct. 10, 2023
(86) PCT No.: PCT/IB2023/060167

§ 371 Date: Apr. 9, 2025

(30) Foreign Application Priority Data
Oct. 12, 2022 (FR) FR2210502

(51) Int. Cl. A62B 23/02; A62B 27/00

(52) U.S. Cl. CPC A62B 23/02; A62B 27/00

(57) ABSTRACT

The invention relates to a respiratory protection method comprising the steps of
1) providing a mask comprising:
   a transparent mask body (1) having a periphery comprising an upper portion (36), a right lateral portion (2), a left lateral portion (3), and a lower portion (4) ;
   a membrane (8) located on the periphery of the transparent mask body (1) ;
   a right retaining means (9) and a left retaining means (10) ; and
2) placing the mask on the face of a user, by positioning the membrane (8), at the lower portion (4) of the periphery of the mask body (1), in contact solely with the underside of the user's jaw.

The invention also relates to a respiratory protection mask suitable for implementing the aforementioned method.

The invention relates to a respiratory protection method and a transparent respiratory protection mask with a replaceable filter.

### BACKGROUND OF THE INVENTION

The Australian patent application published under number AU2020102286 relates to a respiratory mask assembly composed of a substantially pear-shaped mask body designed to come into contact with the user's face, a stiffening element removably attached to the mask body on the inside, a removable mask cover placed on the outside of the mask body, at least one filter assembly for air intake through the mask cover, mask body, and stiffening element, an expiration assembly forming an air outlet through the mask body. The mask cover includes two straps for securing the mask to the user's head and holding the entire assembly in place.

The Spanish patent application published under number ES 2 778 000 concerns a reusable respiratory protection mask designed to be applied to the nose and lower face. It is fixed with bands that go around the ears and head, connected to two circular lateral protrusions containing filters. Additionally, a lower protrusion is designed to accommodate electronic devices. This mask is transparent to facilitate communication and facial recognition. However, it is not adaptable, and its entire contour is pressed against the user's face, preventing any jaw movement without causing the mask to lift or shift, leading to leaks and significantly reducing its effectiveness and reliability.

The Chinese patent application published under number CN 107 929 967 and the Chinese utility model published under number CN 208 097 144 describe a respiratory mask including:
A transparent mask body with an upper part, a right lateral part, a left lateral part, and a lower part;
A sealing element for facial contact positioned around the mask body's perimeter;
At least one lateral filtration assembly;
A right holding means and a left holding means for securing on a face.
   wherein:
The upper perimeter of the mask body features a right curve and a left curve that extend from its center, curve downward, and then rise upward;
The lower perimeter of the mask body is horizontal;
The right and left lateral parts of the mask body are vertical;
The right and left retention means are fixed at the angles formed between the upper part and the right and left lateral parts of the mask body's perimeter, respectively;
The membrane protrudes relative to the mask body, having one end fixed to the mask body and a free end, and, at the upper perimeter of the mask body, the free end of the membrane extends perpendicularly to the mask body.

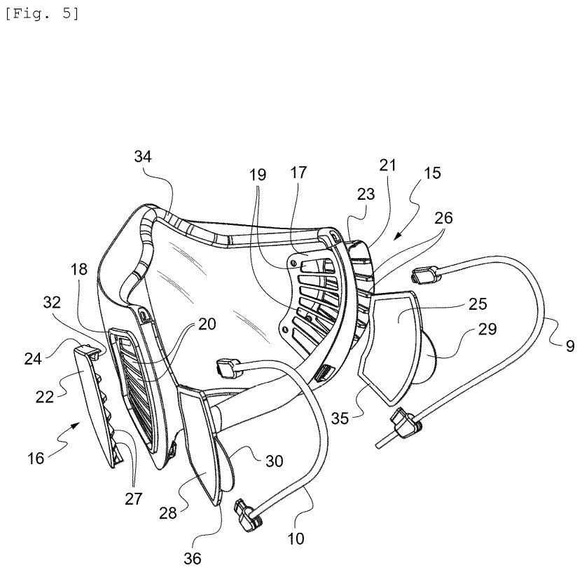

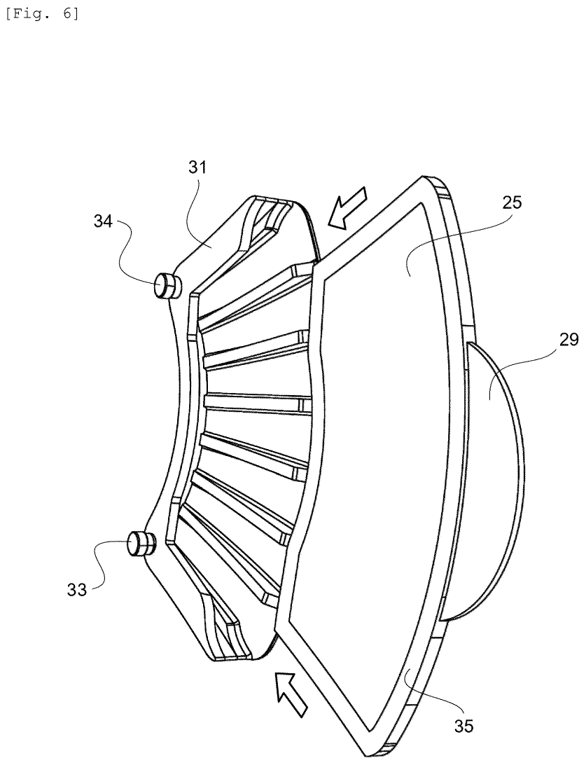

In this mask, the sealing element designated by reference 103, which is best seen in FIGS. 5 and 6 of these Chinese documents, is a sealing ring with a U-shaped cross-section whose free ends are curved towards each other.

This mask must be secured both to the user's ears and around their neck, increasing the user's discomfort.

Its lower part is therefore designed to be pressed against the user's chin by fastening 510, which has the disadvantages that the user can hardly speak, and if they do, the movement of their lower jaw causes an unpleasant sliding of the chin on the sealing ring, compromising the mask's seal. In any case, this mask is not designed to allow communication, as it is equipped with two fans located near the user's ears, preventing proper hearing of surrounding sounds.

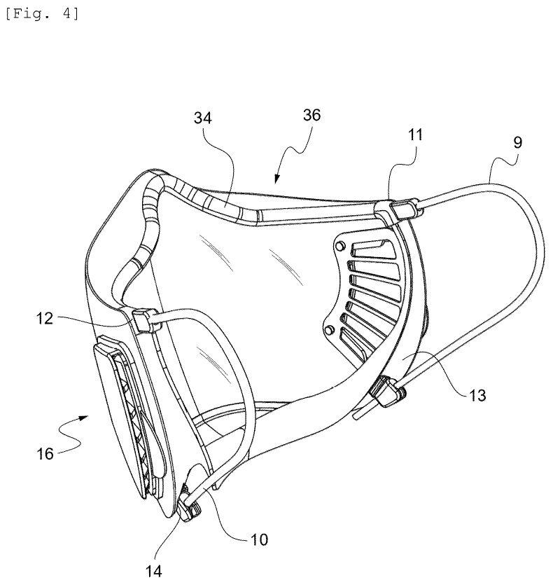

French patent number FR 773 129 discloses a respiratory mask. As described in this patent and particularly illustrated in FIG. 4, this mask is intended to be applied by pressure against the user's face. Thus, it is impossible for the user of such a mask to speak once it is in place.

The U.S. patent application published under number US2017/0007861 proposes a respiratory mask comprising a facial sealing element, designed, as indicated in paragraph [14] of this application, to surround the nasal and oral regions of the user. As shown particularly in FIG. 5, once the mask is pressed against the user's face, they are unable to speak.

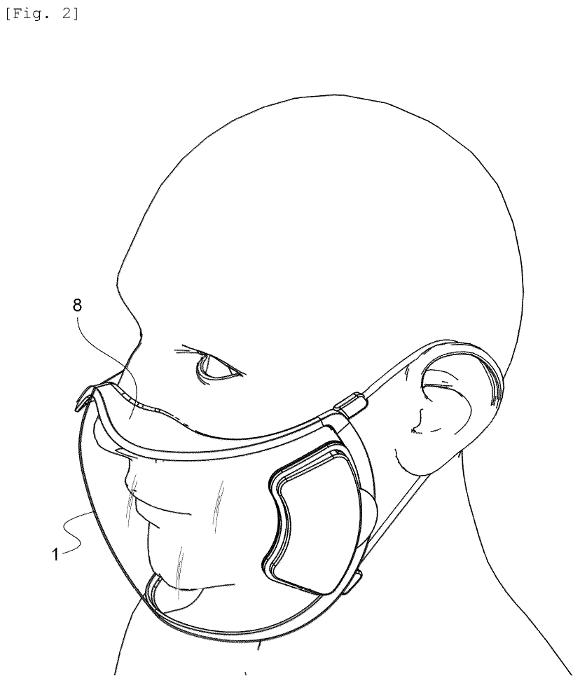

The Korean patent application published under number KR 2005 0042986 discloses a transparent mask intended to cover the nose and mouth of its user. As clearly shown in FIGS. 2 and 11 of this application, the user cannot speak when wearing the mask because any movement of their lower jaw would result in a loss of seal.

### SUMMARY OF THE INVENTION

The primary objective of the invention is to propose a respiratory protection method using a transparent respiratory protection mask that is adjustable to the wearer's face, comfortable, highly breathable, allows the wearer to speak while maintaining a secure fit and seal, is reliable and reusable, and enables easy replacement of filters.

To achieve this objective, the inventor has designed a mask whose lower part does not press against the chin but rather against the area beneath the chin. This design allows the user to speak freely without compromising the mask's seal.

Such a result is achieved by providing that the seal is ensured by a protruding membrane, positioned at the lower perimeter of the mask body, extending from the mask body's perimeter at an upward incline, with its free end curving downward.

The positioning and flexibility of the membrane minimally hinder downward movements of the lower jaw, absorbing these slight movements due to the membrane's proximity to the jaw joint. This design prevents discomfort to the user thanks to the curved end of the membrane, which also allows for smooth adaptation beneath the chin while maintaining the mask's seal.

Additionally, the curved shape of the mask body enhances the proximity of the membrane's free end to the lower jaw joint.

According to the invention, this objective is achieved using a respiratory protection method defined in the following claim:
1. respiratory protection method comprising the steps of:
   1) Providing a mask comprising:
      A transparent mask body with a perimeter including an upper part, a right lateral part, a left lateral part, and a lower part;
      A membrane positioned along the perimeter of the transparent mask body;
      At least one assembly, preferably lateral;
      A right and a left securing means ;
         The upper perimeter of the mask body featuring a right curve and a left curve extending from the center, curving downward, and then rising upward,
         The lower perimeter of the mask body being horizontal,
         The right and left lateral parts of the mask body being vertical,
         The right and left securing means being fixed at the angles between the upper and lateral parts of the mask body's perimeter, respectively;
         The membrane protruding from the mask body, with one end fixed to the mask body and a free end, the free end extending perpendicularly at the upper perimeter,
         At the lower perimeter of the mask body, the membrane protruding upward at an inclined angle with the free end curving downward.
   2) Placing the mask on a user's face, ensuring that the membrane at the lower perimeter of the mask body contacts only the underside of the user's jaw.

Advantageous features of the method of claim 1 are indicated in the following claims:
2. The respiratory protection method of claim 1, furthercomprising a preliminary step of selecting a suitable mask for the user.
3. The respiratory protection method according to claim 3, wherein the preliminary step of selecting a mask for the user includes a fit test.
4. The respiratory protection method according to claim 3, wherein the fit test is carried out using a shutter, such as a mask fit test shutter.

If there is no sealing, it means that the mask is improperly fitted, that is to say, improperly positioned on the user's face and/or that its size is unsuitable for the user.

The assembly is preferably lateral and is preferably a filtration assembly. Preferably, two assemblies are provided, preferably one on each side (right and left) of the mask body.

The invention also relates to a mask according to claim 5 as follows:
5. Respiratory protection mask suitable in particular for implementing the method according to any one of the preceding claims, comprising:
   a transparent mask body whose perimeter comprises an upper part, a right lateral part, a left lateral part, and a lower part;
   a membrane located on the perimeter of the transparent mask body;
   at least one assembly, preferably lateral;
   a right retention means and a left retention means;
      the upper part of the perimeter of the mask body comprising a right curvature and a left curvature which start from its center, curve downward, and then curve upward;
      the lower part of the perimeter of the mask body being horizontal;
      the right and left lateral parts of the mask body being vertical;
      the right and left retention means being attached to the angles formed between the upper part and the right and left lateral parts of the perimeter of the mask body, respectively, and
      the membrane protruding from the mask body, having one end fixed to the mask body and a free end, and, at the upper part of the perimeter of the mask body, the free end of the membrane extending perpendicularly away from the mask body,
         this mask being characterized in that, at the lower part of the perimeter of the mask body, the membrane protrudes from the perimeter of the mask body to which it is fixed, in an upwardly inclined manner, and its free end curves downward.

Advantageous features of the mask of claim 5 are indicated in the following claims:
6. Mask according to claim 5, wherein the mask body is curved from the upper part to the lower part.
6bis. Mask according to claim 5 or 6, wherein the mask body has the shape of a portion of a sphere.
7. Mask according to any one of claims 5 to 6bis, wherein the assembly or assemblies, preferably lateral, is or are at least partially made of polypropylene (PP) and/or polylactic acid (PLA) and/or polyhydroxyalkanoate (PHA) and/or biopolyester.
7bis. Mask according to any one of claims 5 to 7, comprising two assemblies, preferably lateral.
8. Mask according to any one of claims 5 to 7bis, wherein the assembly or assemblies, preferably lateral, has or have a perforated base, a cover having a main side and a lateral wall on only part of its periphery, so as to leave one side open, preferably facing the rear of the mask.
9. Mask according to claim 8, further comprising a filter inserted between the cover and the perforated base.
10. Mask according to claim 8, further comprising a shutter inserted between the cover and the perforated base.
11. Mask according to any one of claims 5 to 10, wherein, at the lateral parts of the perimeter of the mask body, the free end of the membrane extends perpendicularly away from the mask body and then curves toward the rear of the mask, with the right and left sides of the membrane approaching each other to form a rounded shape.
12. Mask according to any one of claims 5 to 11, wherein the width of the membrane increases from top to bottom at the lateral parts and the perimeter of the mask body.
13. Mask according to any one of claims 5 to 12, wherein:
   the right retention means forms a loop with the perimeter of the mask body by also being attached at the junction of the lower part and the right lateral part of the mask body, and
   the left retention means forms a loop with the perimeter of the mask body by also being attached at the junction of the lower part and the left lateral part of the mask body.
14. Mask according to any one of claims 5 to 13, wherein the retention means are attached to the mask body in an adjustable manner.
15. Mask according to claim 8 or any one of claims 9 to 14 when they are dependent on claim 8, wherein each main side is provided, on its side facing the base, with ribs.
16. Mask according to claim 8 or any one of claims 9 to 15 when they are dependent on claim 8, wherein the covers are provided, at the ends of their lateral walls opposite the main sides, with rims.
17. Mask according to claim 9 or 10, or any one of claims 10 to 16 when they are dependent on claim 9 or 10, wherein each filter or shutter includes a tab.
18. Mask according to any one of claims 5 to 17, wherein each lateral assembly forms a cassette and/or each filter forms a cartridge, each cassette and each cartridge having the shape of an isosceles trapezoid whose parallel sides have been curved concentrically.
19. Mask according to claim 9 or any one of claims 11 to 18, when they are dependent on claim 9, wherein each filter has a frame within which a porous material is located.

It goes without saying that the features of claims 5 to 19 also apply to the mask mentioned in the method of claims 1 to 4.

The invention also relates to the use of the mask according to the invention to ensure the respiratory protection of a person, wherein the mask is placed on the person's face, with the membrane, at the lower part of the perimeter of the mask body, being in contact only with the underside of the person's jaw.

Preferably, this use includes a preliminary step of selecting a mask for this person (the user). This selection step preferably includes a fit test. This fit test is preferably carried out using a shutter, such as a mask fit test shutter.

According to another aspect, the invention also relates to a method for manufacturing the aforementioned mask, which is characterized in that it includes a bi-injection step. According to yet another aspect, the invention relates to a method for testing the sealing of a mask with a replaceable filter.

In which a shutter is used in place of a filter. This method can be used with any mask with a replaceable filter, and in particular with the mask according to the invention.

Thus, the user of the mask inserts a shutter that has substantially the same dimensions as a filter, such as a mask fit test shutter, in the location where the filter is usually positioned. Then, by inhaling and exhaling, the user checks the sealing of the mask. This procedure is easier to implement than the techniques used until now, and it is much more reliable than the method of blocking the mask with the hands.

Other features and advantages of the invention will now be described in detail in the following description, which is provided with reference to the accompanying figures, which schematically represent:

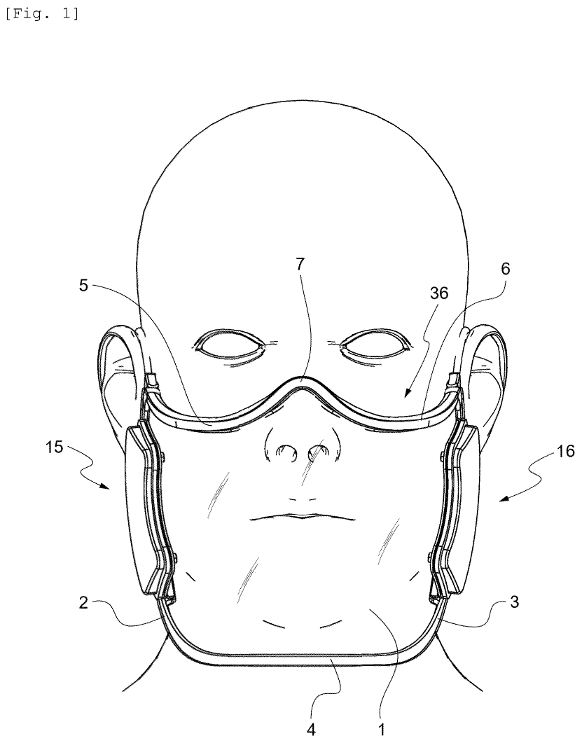

FIG. 1: The mask according to the invention, in a front view, fitted on a wearer;

FIG. 2: The mask of FIG. 1, in a side view;

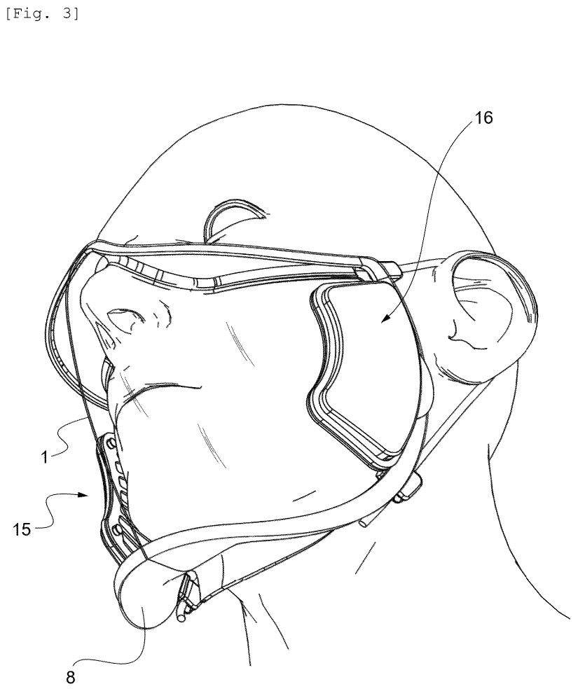

FIG. 3: The mask of FIGS. 1 and 2, in a side and bottom view;

FIG. 4: The mask of FIG. 1, in a rear perspective view;

FIG. 5: The mask of FIG. 4, in an exploded view;

FIG. 6: Apart of a lateral filtration assembly of a mask according to the invention, before assembly;

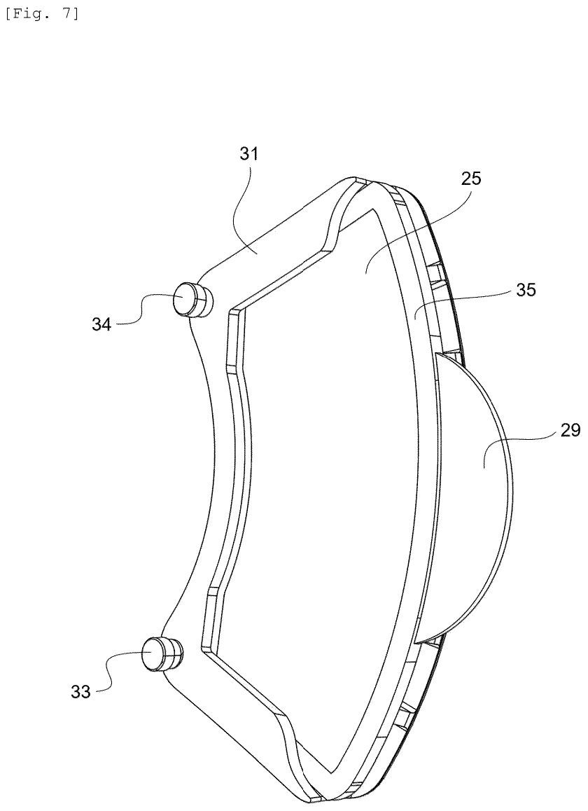

FIG. 7: The part of FIG. 6, after assembly;

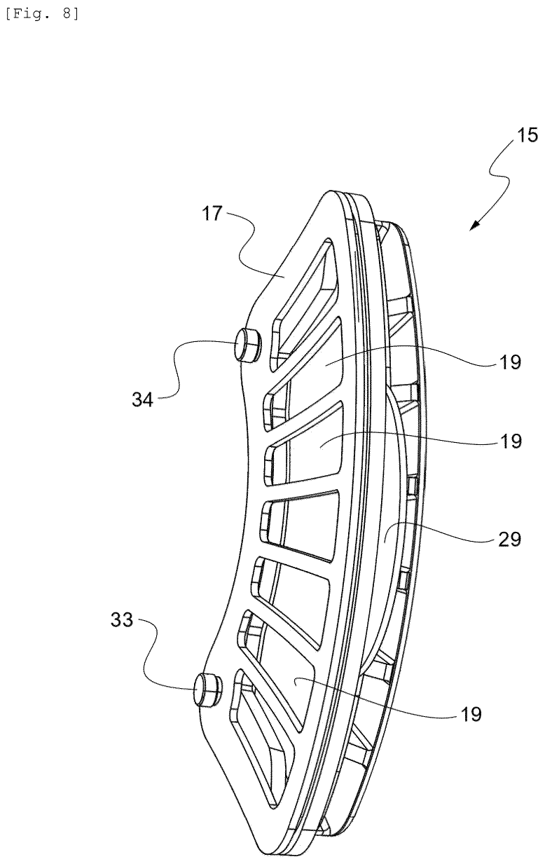

FIG. 8: A complete lateral filtration assembly of a mask according to the invention;

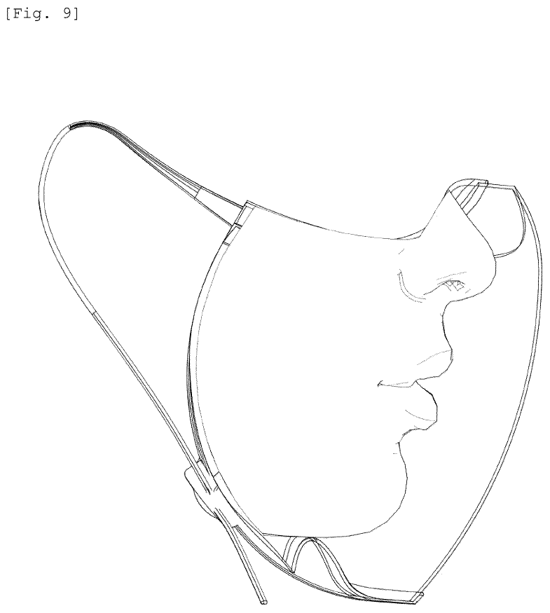

FIG. 9: Aprofile view of a user wearing the mask according to the invention.

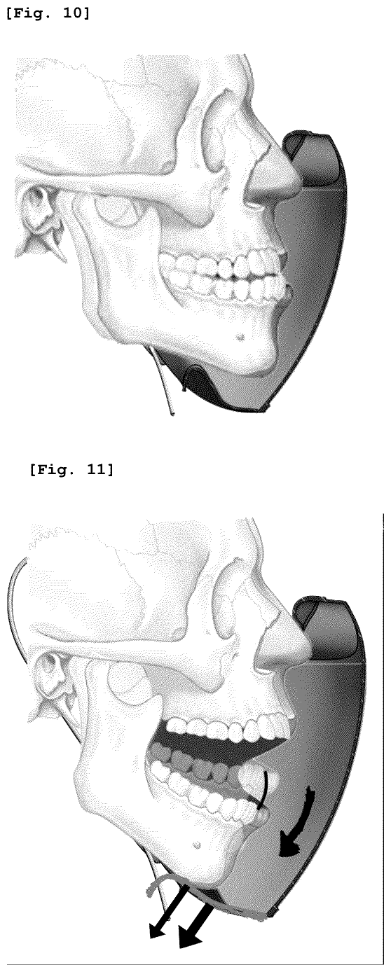

FIG. 10: Aprofile cross-sectional view of the skeleton of a user wearing the mask according to the invention, with the mouth closed; and

FIG. 11: Aprofile cross-sectional view of the skeleton of the user of FIG. 10, now with the mouth open and, consequently, the lower jaw moved downward.

### DETAILED DESCRIPTION OF THE INVENTION

An exemplary embodiment of the transparent respiratory protection mask according to the invention is illustrated in FIGS. 1 to 11.

To better understand its operation, it is recalled that, from a medical standpoint, the normal mouth opening corresponds to three fingers placed vertically, one above the other. As shown in FIGS. 10 and 11, the opening of the mouth occurs through a tilting movement of the lower jaw toward the rear and downward due to the complex motion of the temporomandibular joint (TMJ), whose axis undergoes a complex movement composed of simultaneous translation and rotation.

The mask according to the invention thus incorporates a unique design with the end of the membrane forming a bulge beneath the lower jaw, which perfectly conforms to the shape of the wearer's chin and has the particularity of flattening and moving backward to follow the complex movement of the jaw. The compression of the bulge during jaw opening allows the membrane to remain hermetically in contact with the lower jaw at all times and to absorb the entire displacement during mouth opening. This structure is responsible for the stability of the mask on the face during speech.

Because the upper part that rests on the nose does not undergo any movement.

In FIG. 1, the mask is shown properly fitted on a wearer and ready for use. This mask first comprises a transparent mask body 1, which is rigid or semi-rigid, whose perimeter includes an upper part 36, a right lateral part 2, a left lateral part 3, and a lower part 4.

The upper part 36 of the perimeter includes a right curvature 5 and a left curvature 6 that originate from its center 7, curve downward, and then curve upward, so as to extend toward the tops of the wearer's ears, while more or less following, at a distance, the contour of their eyes.

The lower part 4 is horizontal, while the lateral parts 2 and 3 are substantially vertical.

Such a shape allows for a larger contact surface of the mask body 1 on the wearer's face, which better distributes the contact pressure compared to known masks. Moreover, it leaves free, on the one hand, the nodal points for human communication, namely the eyes, nose, and mouth, and on the other hand, the areas used by facial recognition algorithms.

In FIGS. 2 and 3, it can be seen that the mask body 1 is provided with a facial contact membrane 8 extending along the perimeter of the mask body 1.

The membrane 8 has one end fixed to the mask body 1 and protrudes from it.

At the upper part 36 of the perimeter of the mask body 1, the free end of the membrane 8, as can be seen in particular in FIG. 1, extends perpendicularly away from the mask body 1, in order to reduce visual obstruction. Thus, the wearer of the mask sees only a narrow strip of the membrane.

At the lateral parts 2 and 3 of the perimeter of the mask body 1, the free end of the membrane 8 also extends perpendicularly away from the mask body 1 and then curves toward the rear of the mask, so as to increase the contact surface and allow absorption of facial movements. Furthermore, the width of the membrane 8 increases from top to bottom, in order to compensate for the natural thinning of the face and to allow the lower part 4 of the perimeter of the mask body 1 to remain horizontal.

At the lower part 4 of the perimeter of the mask body 1, the membrane 8 protrudes from the perimeter of the mask body 1 to which it is fixed, in an upwardly inclined manner, and its free end curves downward, as shown particularly in FIG. 4. This curvature increases the contact surface with the lower jaw and provides sealing at this level, as well as stability during movements of the lower jaw.

Indeed, as can be seen more clearly in particular in FIG. 9, thanks to its upwardly inclined part and its free end curving downward, the membrane 8 can absorb the downward movements of the lower jaw while ensuring sealing, and its downward curvature prevents uncomfortable pressure against the jaw for the user.

Moreover, the right and left sides of the membrane 8, as shown particularly in FIGS. 4 and 5, approach each other to form a rounded shape.

The combination of the increase in the width of the membrane 8 at the bottom of the lateral parts 2 and 3 of the perimeter of the mask body 1, and the convergence of the right and left sides The combination of the increase in the width of the membrane 8 at the bottom of the lateral parts 2 and 3 of the perimeter of the mask body 1, and the convergence of the right and left sides of the membrane 8 at the lower part 4 of the perimeter of the mask body 1, results in obtaining a rounded shape that conforms to the user's chin, with high adaptability due to the flexibility of the membrane 8.

By keeping the mask body 1 at a distance from the face, the membrane 8 creates a volume in front of the respiratory orifices, which facilitates breathing and air circulation. Thanks to this, the wearer does not need to exert respiratory effort and can breathe normally.

As shown in FIG. 4, the mask according to the invention includes a right retention means 9 and a left retention means 10 for securing the mask to the wearer's face, designed to pass around the ears or the head. These right 9 and left 10 retention means are attached, on the one hand, to the angles 11 and 12 formed between the upper part 36 and the right lateral part 2 and left lateral part 3, respectively, and, on the other hand, to the junctions 13 and 14 of the lower part 4 and the right lateral part 2 and left lateral part 3, respectively, of the perimeter of the transparent mask body 1.

This allows for a primary support of the membrane 8 on the face along the entire upper part 36 of the mask body 1, a lighter support of the membrane 8 at the lateral parts 2 and 3, and an even lighter support at the lower part 4.

Preferably, the size of the mask body 1, particularly the length of the lateral parts 2 and 3 of the perimeter, is designed so that the lower part 4 is positioned below the user's chin, as is clearly shown in FIGS. 1 to 3.

The mask body 1 is generally curved from the upper part to the lower part. It may therefore have a generally substantially spherical portion shape, which has, among other advantages, the ability to prevent extensive light reflection and to provide a comfortable space in front of the wearer's nose and mouth.

The membrane 8 allows, on the one hand, adaptability of the mask body 1 to different faces, and on the other hand, the movement of the face (speaking, grimacing, and other facial expressions), due to the stability of the fit.

The most significant pressure is exerted at the upper part 36, and the free end of the membrane is preferably provided with an additional facial contact element 34, as shown particularly in FIG. 4, which softens and reduces the pressure on the face.

The support of the mask body on the face can also be adjusted using the right 9 and left 10 retention means, whose length can be varied through their attachments to the mask body 1, as shown in FIG. 4. In this figure, the lower parts of the retention means 10 and 11 are held, at the junctions 13 and 14, by clamp-like elements within which the retention means 9 and 10 can be slid by pulling them in one direction or the other.

Returning specifically to FIG. 1, air filtration assemblies 15 and 16 can be seen on each side of the mask body 1. Indeed, since the mask body 1 is impermeable and the membrane 8 ensures the sealing of the mask's interior, it is necessary to allow the passage of air so that the wearer can inhale and exhale normally.

The air filtration assemblies 15 and 16 are shown in detail in FIG. 5. Each of them is composed of a base 17, 18 that is attached to an opening that is approximately The same dimension provided laterally in the mask body 1.

Bases 17 and 18 comprise openings 19 and 20 for air intake and exhaust, the air filtration assemblies 15 and 16 being thus bidirectional.

Flaps are mounted on bases 17 and 18. Each flap comprises a main side 21, 22, and, arranged perpendicularly to it, a lateral wall 23, 24 along part of their periphery, leaving one side open for the insertion of filters 25, 28. The air flows exclusively through this open side, which is oriented towards the rear. This arrangement prevents splashes or droplets from reaching the active surfaces of the filters.

The main sides 21 and 22 are provided, on their faces facing the bases 17 and 18, with ribs 26 and 27 designed to create an air circulation volume between the main sides 21 and 22 of the flaps and the filters 25 and 28, and to form a stabilizing support for them.

The other faces of the main sides 21 and 22, those facing the outside of the mask, may bear various information (name, brand, logo, design, etc.).

FIG. 6 shows the insertion of filter 25 into its flap, and FIG. 7 shows filter 25 in its normal position of use.

To facilitate its installation and removal, each filter 25, 28 preferably includes a tab 29, 30. The flaps may be provided, at the ends of their lateral walls 23, 24 opposite to the main sides 21, 22, with edges 31, 32 intended both to come into contact with the bases 17, 18 and to create a filter compartment, as illustrated particularly in FIGS. 6 and 7.

Furthermore, the flaps include rivets 33, 34 passing through corresponding holes provided in the bases 17, 18 (see FIG. 8) and securing to the mask body 1, in order to firmly and hermetically attach the flaps to the mask body.

It goes without saying that the filters 25, 28 are intended to cover all the openings 19, 20, and that the tabs 29 and 30 preferably remain outside the filtration assemblies to be accessible.

Preferably, the filters 25, 28 have a rigid, impermeable frame 35, 36, within which a porous material is located.

Thus, the air filtration assemblies 15, 16 serve as cassettes, while the filters 25, 28 function as cartridges.

Different types of filters can be accommodated to achieve various types of filtration.

Such a design of the air filtration assemblies 15 and 16 offers the advantage of allowing easy replacement of the filters 25, 28, which can moreover be performed without having to remove the mask or even detach any of its components. This is achieved simply by sliding each filter 25, 28 into the filter compartment of the respective air filtration assembly 15, 16, between two parallel internal faces of the lateral walls 23, 24, until it comes into contact with the face of the lateral wall 23, 24 opposite to the entrance of the filter compartment.

In FIGS. 6 and 7 in particular, it can be seen that the filtration assemblies 15 and 16, when projected onto a plane, have substantially the shape of an isosceles trapezoid whose parallel sides have been curved concentrically, with the shorter side of the trapezoid preferably being closest to the center of the virtual circle.

The filters 25 and 27, disregarding the tabs 29 and 30, have the same shape. This shape facilitates the insertion of the filters 25 and 27 into the filter compartments, thanks to their curved shorter sides.

### Materials and Manufacturing

The respiratory protection mask can be manufactured using known materials and, for example, by bi-injection, overmolding, or thermoforming. Preferably, simultaneous or sequential bi-injection of the membrane 8 and the mask body 1 is employed.

The membrane is preferably made of an elastomer such as a thermoplastic elastomer (TPE) and/or a styrenic thermoplastic elastomer (TPE-S), or possibly silicone.

The mask body 1 is made of transparent injectable plastic materials or biomaterials.

The lateral assemblies 15, 16 are at least partially made of polypropylene (PP) and/or polylactic acid (PLA) and/or polyhydroxyalkanoate (PHA) and/or biopolyester.

The filter frames are generally made of injectable thermoplastic elastomer materials.

The porous filtering materials vary depending on the desired type of filtration. For example, the filter may be made of polypropylene or an equivalent material for infectious particle filters.

The transparent mask according to the invention is preferably available in three sizes, so as to fit the majority of human faces, with additional rare sizes available to accommodate certain facial morphologies.

The entire mask, with the obvious exception of the filters, is reusable after disinfection by washing.

1. A mask comprising:
a transparent mask body (1) having a perimeter comprising an upper portion (36), a right lateral portion (2), a left lateral portion (3), and a lower portion (4); said mask body (1) being curved from the upper portion (36) to the lower portion (4),
a membrane (8) located on the perimeter of the transparent mask body (1);
at least one unit (15, 16);
a right means (9) and a left means (10);
the lower portion (4) of the perimeter of the mask body (1) is horizontal,
the right lateral portion (2) and left lateral portion (3) of the mask body (1) are vertical,
the right means (9) and the left means (10) are fixed at the angles (11,12) formed between the upper portion (36) and the right lateral portion (2) and left lateral portion (3) of the perimeter of the mask body (1), respectively,
the membrane (8) extends outward from the mask body (1) having one end fixed to the mask body and a free end, wherein, at the upper portion (36) of the perimeter of the mask body (1), the free end of the membrane (8) extends perpendicularly away from the mask body (1), and
the upper portion of the perimeter of the mask body (1) comprises a right curvature (5) and a left curvature (6) originating from its center (7), curving downward and then rising upward,
characterized in that:
the membrane (8) increases in width from top to bottom along the lateral portions of the mask body perimeter (1),
at the lower portion (4) of the perimeter of the mask body

(1) the membrane (8) extends outward, from the perimeter of the mask body (1) to which it is fixed, inclined upward, with its free end curving downward,
The dimension of the mask body (1) is configured so that the lower portion (4) is positioned under the user's chin.
and wherein the assembly or assemblies (15,16) is/are at least partially composed of polypropylene (PP) and/or polylactic acid (PLA) and/or polyhydroxyalkanoate (PHA) and/or biopolyester.

2. The mask according to claim 1, wherein, at the lateral portions (2) and (3) of the perimeter of the mask body (1), the free end of the membrane (8) extends perpendicularly away from the mask body (1) and then curves towards the back of the mask, with the right and left sides of the membrane (8) converging to form a rounded shape.

3. The mask according to one of claims 1 and 2, comprising two assemblies (15,16).

4. The mask according to one of claims 1 to 3, wherein the assembly or assemblies (15,16) have a perforated base (17,18), a cover having a main side (21,22) and a lateral wall (23,24) on only part of its periphery, leaving one side open, preferably oriented towards the back of the mask.

5. The mask according to claim 4, further comprising a filter (25,28) or a shutter inserted between the cover and the perforated base (17,18).

6. The mask according to one of claims 1 to 5, wherein:
the right means (9) forms a loop with the perimeter of the mask body (1) and is also fixed at the junction (13) of the lower portion (4) and the right lateral portion (2) of the mask body (1), and
the left means (10) forms a loop with the perimeter of the mask body (1) and is also fixed at the junction (14) of the lower portion (4) and the left lateral portion (3) of the mask body (1).

7. The mask according to one of claims 1 to 6, wherein the right means (9) and the left means (10) are adjustably fixed to the mask body (1).

8. The mask according to claim 4 or one of claims 4 to 7 when dependent on claim 4, wherein each main side (21,22) is provided on its side facing the base (17,18) with ribs (26,27).

9. The mask according to claim 5 or one of claims 6 to 8, when dependent on claim 5, wherein each filter (25,28) or shutter includes a tab (29,30).

10. The mask according to claim 5 or one of claims 6 to 9, when dependent on claim 5, wherein each filter (25,28) has a frame (35,36) containing a porous material inside

11. Amethod for ensuring the respiratory protection of a user, using a mask according to one of claims 1 to 10, the mask being placed on the user's face, with the membrane (8) at the lower portion (4) of the perimeter of the mask body (1) being in contact only with the underside of the user's jaw.

12. The method according to claim 11, comprising a preliminary step of selecting a mask for the user, this step including a fit test.

13. The method according to one of claims 11 and 12, wherein the width of the membrane (8) of the mask increases from top to bottom along the lateral portions of the perimeter of the mask body (1) 14. A method of manufacturing a mask according to one of claims 1 to 10, comprising a step of bi-injection, overmolding, or thermoforming.

15. The manufacturing method according to claim 14, comprising simultaneous or sequential bi-injection of the membrane (8) and the mask body (1).
